(19) United States
(12) Patent Application Publication
(10) Pub. No.: US 2006/0180507 A1
(43) Pub. Date: Aug. 17, 2006

(54) Method for reclaiming concrete

(76) Inventors: Michael Robert DeHart, Seabrook, TX (US); Lee Roy Jackson, Arcola, TX (US)

Correspondence Address: Anastassios Triantaphyllis, P.O. Box 27629, Houston, TX, 77227, US

(21) Appl. No.: 11/357,002

(22) Filed: Feb. 16, 2006

Related U.S. Application Data
(63) Continuation-in-part of application No. 10/053,720, filed on Jan. 17, 2002, now abandoned.
(60) Provisional application No. 60/262,546, filed on Jan. 16, 2001.

(51) Int. Cl. B03B 7/00; B07B 1/28; B07B 1/04

(52) U.S. Cl. 209/311; 209/17; 209/352; 209/235

(57) ABSTRACT

A method and apparatus for reclaiming uncured concrete are disclosed. Uncured concrete containing gravel, sand and cement is mixed with water in a concrete hopper and the resultant slurry flows to a screen where the gravel is separated from the rest of the slurry material. The gravel free material flows to a separator where the sand is removed by gravity from the remaining cement water mixture. The cement water mixture flows to a tank where the cement settles out of the water by gravity. Water containing unsettled cement is recirculated to mix it with uncured concrete in the concrete hopper.

### RELATED PRIORITY DATE APPLICATION

This application is a continuation in part application of co-pending application Ser. No. 10/053,720, filed on Jan. 17, 2002, which claims the benefit under 35 U.S.C. 119(e) of the U.S. provisional application No. 60/262546 filed on Jan. 17, 2001.

### TECHNICAL FIELD OF THE INVENTION

The present invention relates to solid/liquid separation, and, more particularly, to a method for reclaiming uncured concrete. Still more particularly, the present invention discloses a method and an apparatus for separating cement, sand, and gravel from uncured mixed concrete for future use.

### BACKGROUND OF THE INVENTION

The wide use of concrete for the construction of roads, buildings and the like is well known. In most building operations utilizing concrete, there is always left over a significant amount of unused, uncured concrete. That concrete is not easily disposable and presents a serious environmental problem. Furthermore, the unused concrete is an economic waste. In order to solve the disposal problem and to reduce the economic waste, methods have been developed to treat and reclaim the concrete for further usage in the preparation of new concrete. Those methods utilize pits which are dug in the ground to recover the concrete material through gravity separation. One difficulty with the use of those pits is that they are fixed and cannot be transported to different locations as the need arises. Still, another disadvantage is the water used in those methods presented disposal problems.

According to the present, an apparatus and a method for reclaiming unused, uncured concrete utilizing portable, above ground equipment that are capable of recovering rock, sand and light cement material for future use. The water being used to assist in the separation is recycled and the need for disposing that water in large quantities is eliminated.

These and other advantages of the present invention will become apparent from the following description and drawings.

### SUMMARY OF THE INVENTION

A concrete reclaimer and a method for separating cement slurry, sand, and gravel from mixed concrete for future use are disclosed. In the preferred embodiment, the concrete reclaimer includes a concrete hopper, a slurry discharge pump, a screening system, a screw conveyor, two water storage tanks and a water supply pump. The concrete hopper is constructed and positioned for receiving uncured concrete discharged from concrete mixer trucks and it includes a concrete receiving compartment for receiving the uncured concrete from the cement truck and an adjoining mixing compartment into which the uncured concrete flows by gravity. Mixing compartment is equipped with a nozzle for injecting high volume of water under pressure pumped by the water supply pump. The slurry discharge pump is connected to pump material from the mixing compartment to the screening system.

The screening system includes a vibrating rectangle screen mounted on springs and positioned at a 45 degree angle over a screw conveyor hopper. A screw conveyor is positioned at a 30 degree upward angle in the bottom of screw conveyor hopper. Two water storage tanks are connected in parallel with an upper end outlet of the screw conveyor hopper via outlet lines corresponding to each tank to receive liquid material from the screw conveyor hopper. Each tank has an outlet opening located about three feet above its bottom. The outlet opening is connected to the water supply pump to provide liquid to said pump.

In operation, uncured concrete containing gravel, sand and cement is discharged from cement mixer trucks in the concrete receiving compartment of the concrete hopper. The concrete flows by gravity to the adjoining mixing compartment. The water supply pump draws water from one of the first water storage tank and injects it in high volume and under high pressure into the mixing compartment. The water washes the sand and gravel out of the concrete mixture and dilutes the concrete making it a watery slurry. The slurry discharge pump removes the watery concrete slurry from the mixing compartment and pumps it to the screening system where the large aggregate or gravel material is screened out by the vibrating screen and discharged by gravity to a stockpile. The remaining slurry which is substantially free of gravel passes through the screen and falls in the screw conveyor hopper where the sand is separated by gravity from the cement and water. The screw conveyor captures the sand that gravitationally falls through the sand/cement/water slurry and pulls it up through the sand/cement/water slurry into its de-watering section and discharges it to a stockpile.

The remaining cement entrained water which is substantially free of sand flows from the screw conveyor hopper to the first water storage tank where the cement settles by gravity. Water with unsettled cement therein is recirculated by the water supply pump to the mixing compartment of the concrete hopper. When the settled cement builds up in the first storage tank beyond a certain level, the operation is interrupted and the accumulated cement is removed from the first water storage tank. The operation is then restarted with the second water storage tank providing the cement entrained water to the water supply pump and receiving the cement entrained water from the screw conveyor hopper.

In another embodiment of the present invention, the concrete reclaimer includes a hopper, a pump, a separator, a sand tank and four water holding tanks, connected in series. The pump is mounted at the bottom of the hopper for pumping material from the hopper to the separator via a hose which is removably connected to the pump. The hopper and the separator are connected to a water distribution manifold by hoses for receiving water recirculated from the four water holding tanks.

The hopper includes a hopper holding tank with an upper edge at a height which is suitable for receiving discharge of waste, uncured concrete from a concrete mixer truck. Several manifolds provide water to the interior portion of the holding tank, the hopper lower water supply and pump cooling nozzles.

The separator is supported above the sand tank by four adjustable legs and has a bottom discharge opening for flowing material from the separator to the sand tank. A chute is attached to the separator for removing material therefrom. A rotatable screen wheel is mounted on the interior of the separator and is driven by a drive mechanism mounted on the outside wall of the separator.

The sand tank is followed by four tanks connected in series with each tank receiving overflow material from the previous tank. Discharge assemblies at the bottoms of each of the four tanks are connected to a hose connected to a water pump that recirculates water and solid material.

In operation, a concrete mixer truck carrying unused, uncured concrete positions its discharge chute over the hopper. The water recirculation pump is activated to begin pumping water to the hopper and the separator. The water is injected through two separate inlets into the upper and lower portions of the hopper. The concrete from the truck and any washed material from the truck concrete container is then discharged into the hopper where is it contacted by the water to create a diluted concrete slurry which is pumped by the pump to the upper portion of the separator. Therein, the water is sprayed through sprayers. The slurry flows by gravity inside the separator. When the slurry reaches the rotating screen wheel rock material of larger diameter is screened out from the slurry and is centrifugally directed to a discharge outlet from the separator. The remaining material comprising cement, sand and water slurry flows by gravity to the bottom of the separator and exits therefrom through its open end to fall by gravity to the sand tank where most of the sand settles. The effluent from the sand tank flows to the fist water holding tank. Overflow from the first tank flows to the second tank, overflow from the second tank flows to the third tank and overflow from the third tank flows to the fourth tank. Water is continuously removed from the bottom of the four tanks to the water pump that recirculates the water. In the process described, the rock is separated from the concrete slurry in the separator, the sand is separated from the water/cement slurry in the sand tank and cement light material is separated from the water in the four water tanks. The separated rock, sand and light cement material are thus recovered for future use.

### BRIEF DESCRIPTION OF THE DRAWINGS

For a detailed description of the preferred embodiments of the invention, reference will now be made to the accompanying drawings wherein:

FIG. 1 is schematic top view of the preferred embodiment of the apparatus of the present invention;

FIG. 2A is schematic top view of another embodiment of the apparatus of the present invention;

FIG. 2B is a schematic rear view of the embodiment of FIG. 2A.;

FIG. 3A is a schematic top view of a section of the apparatus of FIG. 2A;

FIG. 3B is a schematic side view of the apparatus of FIG. 3A;

FIG. 3C is a schematic bottom view of the apparatus of FIG. 3A;

FIG. 4 is a schematic side view of another section of the apparatus of FIG. 2A;

FIG. 5 is a schematic side view of a section of the apparatus of FIG. 4;

FIG. 6 is a schematic side view of another section of the apparatus of FIG. 2A;

FIG. 7A is a schematic top view of a section of the apparatus of FIG. 4;

FIG. 7B is schematic side view of the apparatus of FIG. 7A;

FIG. 8A is a schematic front view of a section of the apparatus of FIG. 4;

FIG. 8B is schematic side view of the apparatus of FIG. 8A;

FIG. 9A is a schematic, perspective side view of a section of the apparatus of FIG. 4;

FIG. 9B is a schematic bottom view of the apparatus of FIG. 9A;

FIG. 10A is a schematic side view of an alternative embodiment of a hopper to be used in the apparatus of the present invention;

FIG. 10B is schematic opposite side view of the apparatus of FIG. 10A;

FIG. 10C is a schematic front view of the apparatus of FIG. 10A;

FIG. 10D is a schematic rear view of the apparatus of FIG. 10A;

FIG. 10E is a schematic top view of the apparatus of FIG. 10A; and

FIG. 10F is a schematic bottom view of the apparatus of FIG. 10B;

### DESCRIPTION OF THE PREFERRED EMBODIMENT

According to the present invention, an apparatus and a method are disclosed for separating cement slurry, sand, and gravel from mixed concrete for future use.

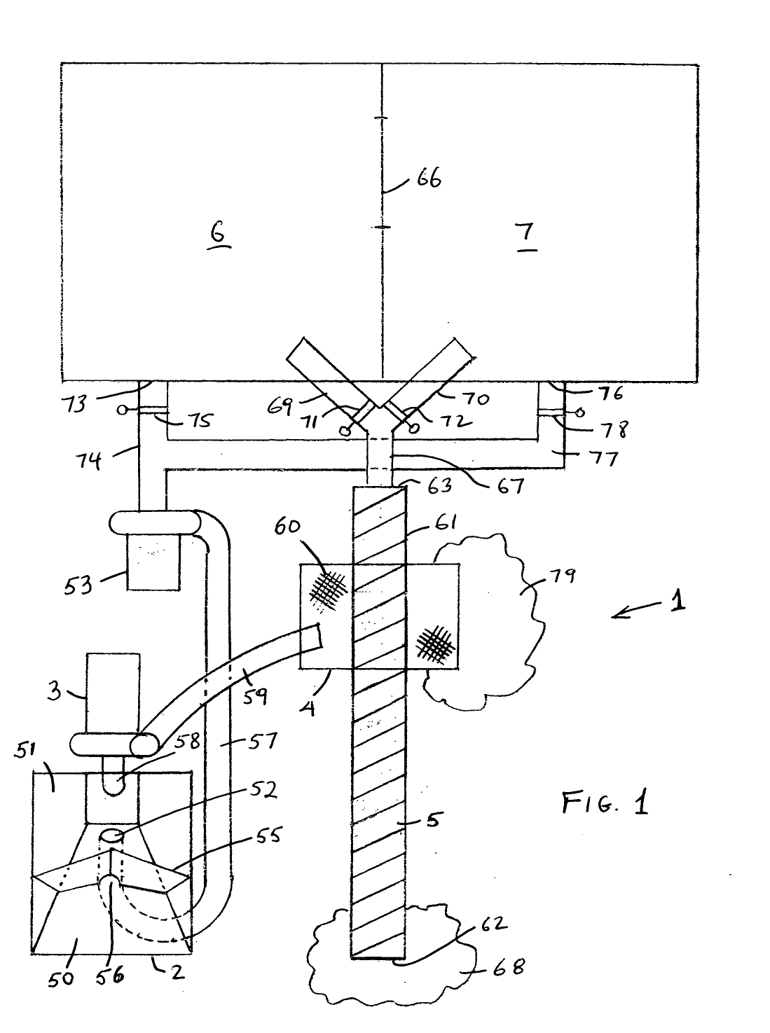

Referring now to FIG. 1, there is shown a concrete reclaimer 1 in accordance with the present invention. Concrete reclaimer I includes a concrete hopper 2, a slurry discharge pump 3, a screening system 4, a screw conveyor 5, water storage tanks 6 and 7 and a water supply pump 53.

Concrete hopper 2 is constructed and positioned for receiving uncured concrete discharged from mixer trucks (not shown). Concrete hopper 2 includes a concrete receiving compartment 50 for receiving the uncured concrete from the cement truck and an adjoining mixing compartment 51 into which the uncured concrete flows by gravity. Concrete receiving compartment 50 has a sloped floor facilitating the uncured concrete to flow into the mixing area. A wall 55 separates concrete receiving compartment 50 and mixing compartment 51 and has an opening 56 for regulating the gravitational flow from concrete receiving compartment 50 to mixing compartment 51. Mixing compartment 51 is equipped with a nozzle 52 into which is pumped a high volume of water under pressure via water line 57 by water supply pump 53 to wash the sand and gravel out of the concrete mixture and to sufficiently dilute the concrete so that it becomes a watery slurry which can be pumped by slurry discharge pump 3 to remove it from mixing compartment 51.

In a typical application, water supply pump 53 is capable of pumping 600 gallons of water per minute at 5 feet of suction head. However, a larger or smaller water supply pump 53 may be used providing less than optimal results and cost of system operation. Water supply pump 53 injects water into mixing compartment 51 via nozzle 52 at a pressure and rate which is sufficiently high so as to remove and cleanse the gravel and sand contained in the uncured concrete matrix and to maintain the sand and gravel in solution in mixing compartment 51.

Slurry discharge pump 3 is positioned so as to remove watery concrete slurry from mixing compartment 51 via slurry suction nozzle 58 and flow it to screening system 4 via a discharge line 59. In a typical application, slurry discharge pump 3 is sufficiently designed to provide capability of pumping 800 gallons of water per minute at zero suction head with solids sized to pass through a 1.5 inch screen.

Screening system 4 includes a generally rectangle screen 60 installed therein having openings that are suitably sized so as to remove and capture gravel (aggregate over a certain size) from the concrete slurry. Screen 60 is positioned at a 45 degree angle over a screw conveyor hopper 61 located beneath screening system 4 to allow the screened gravel to be discharged from screening system 4 by gravitational flow. Screen 60 is mounted on springs which cause the screen to vibrate and more effectively enable the discharge of the gravel to a stockpile. As the concrete slurry is directed onto screen 60, the gravel is removed and the sand/cement/water slurry passes through screen 60 into screw conveyor hopper 61 located beneath screening system 4.

Screw conveyor 5 is positioned at a 30 degree upward angle in the bottom of screw conveyor hopper 61 underneath screening system 4. Screw conveyor 5 has a high end 62 and a low end 63. Screw conveyor hopper 61 is sized to handle the flow of the concrete slurry supplied by slurry discharge pump 3 which is typically up to 800 gallons per minute and to provide sufficient residence time to allow for the gravitational separation of the sand from the slurry. Screw conveyor 5 captures the sand that gravitationally falls through the sand/cement/water slurry captured in screw conveyor hopper 61. Screw conveyor 5 whose lower section is submerged in the sand/cement/water slurry pulls the sand up through the sand/cement/water slurry into the de-watering section of the screw conveyor (the section which is above the surface of the sand/cement/water slurry and ultimately discharges the sand at high end 62 of screw conveyor 5 onto a stockpile outside screw conveyor hopper 61. In a typical application, screw conveyor 5 is sized to remove and discharge up to 30 tons of sand per hour. Screw conveyor hopper 61 has an opening 67 at the top to discharge the remaining cement entrained water to tanks 6 and 7 via discharge lines 69 and 70, respectively.

Tanks 6 and 7 are above ground water storage tanks which are connected to screw conveyor hopper 61 via discharge lines 69 and 70, respectively, and are designed to receive and store cement entrained water discharged from screw conveyor hopper 61. Valve 71 in discharge line 69 and valve 72 in discharge lines 70 regulate the flow of cement entrained water therethrough to tanks 6 and 7, respectively. Tanks 6 and 7 are connected by a weir 66 so that overflow from tank 6 can flow to tank 7 and vice versa.

It should be understood that even though the preferred embodiment is described as having two water tanks, more tanks may be used. Further, below ground level tanks may be used.

Tank 6 has an outlet opening 73 located about three feet above the bottom of tank 6. Outlet opening 73 is connected to the suction of water supply pump 53 via a line 74 to provide water to water supply pump 53. Valve 75 regulates the flow of water through line 74. Tank 7 has an outlet opening 76 located about three feet above the bottom of tank 7. Outlet opening 76 is connected to the suction of water supply pump 53 via a line 77 to provide water to water supply pump 53. Valve 78 regulates the flow of water through line 77.

In operation uncured concrete containing gravel, sand and cement is discharged from mixer trucks (not shown) in concrete receiving compartment 50 of concrete hopper 2. The uncured concrete flows by gravity through opening 56 to adjoining mixing compartment 51. Water supply pump 53 draws water from tank 6 via line 74 and injects it in high volume and under high pressure into mixing compartment 51 via nozzle 52. The water washes the sand and gravel out of the concrete mixture and dilutes the concrete making it a watery slurry to facilitate its removal from mixing compartment 51 using slurry discharge pump 3. The water supplied is at a pressure and rate which is sufficiently high as to remove and cleanse the gravel and sand contained in the uncured concrete matrix and to maintain the sand and gravel in solution in mixing compartment 51.

Slurry discharge pump 3 removes the watery concrete slurry from mixing compartment 51 and pumps it to screening system 4 via discharge line 59. The slurry flows onto vibrating screen 60 where the large aggregate or gravel material is screened out and discharged by gravity to stockpile 79. The remaining slurry which is substantially free of gravel contains the smaller size material comprising sand, cement and water which passes through screen 60 into screw conveyor hopper 61 where the sand is separated by gravity from the cement and water. Screw conveyor 5 captures the sand that gravitationally falls through the sand/cement/water slurry in screw conveyor hopper 61. Screw conveyor 5 pulls the sand up through the sand/cement/water slurry into its de-watering section (the section which is above the surface of the sand/cement/water slurry) and ultimately discharges the sand at high end 62 to stockpile 68. The wet sand so discharged has a small amount of cement which remains therein because of the water present in the wet sand. The remaining cement entrained water which is substantially free of sand flows through opening 67 of screw conveyor hopper 61 as cement water effluent to tank 6 via line 69. Line 70 is closed to prevent the flow to tank 7 via line 70. The cement entrained water flowing out of screw conveyor hopper 61 is a polluting fluid and should be contained to avoid damaging the environment surrounding the concrete reclamation system. In tank 6, the cement contained in the cement entrained water settles to the bottom of water storage tank 6 by gravity. The water with unsettled cement therein is recirculated by water supply pump 53 pump which draws it from tank 6 via line 74 and injects it to mixing compartment via line 57.

As the settled cement builds up in the bottom of water storage tank 6, the level of the cement entrained water may rise and flow into adjacent water storage tank 7 via weir 66. Over time the settled cement reaches the level of opening 73. Then, the reclamation process is stopped, valve 71 is closed and valve 72 is opened and water is removed from water storage tank 6 via water supply pump 53 and is pumped to water storage tank 7. Once the water is removed from water storage tank 6, water supply pump 53 and slurry discharge pump 3 are shut down. A waterproof door (not shown) in water storage tank 7 is opened and the settled cement is removed. The settled cement is inert and has use as road base or can be disposed into a land fill.

After the cement is removed from water storage tank 6, the waterproof door of water storage tank 6 is closed. Then, valve 75 is closed and valve 78 is opened. The concrete reclamation system is restarted by providing the cement entrained water to water supply pump 53 from water storage tank 7 via line 77 and by discharging the cement entrained water from screw conveyor hopper 61 to water storage tank 7 via line 70. In this mode of operation, water storage tank 6 becomes the recipient of cement entrained water overflowing from water storage tank 7. The reclamation process is continued until the settled cement in tank 7 reaches the level that requires removal, as previously described in connection with the accumulation of settled cement in water storage tank 6. Then the previously described operation is repeated to remove the cement from water storage tank 7 and to switch to water storage tank 6 as the cement entrained water recipient form screw conveyor hopper 61.

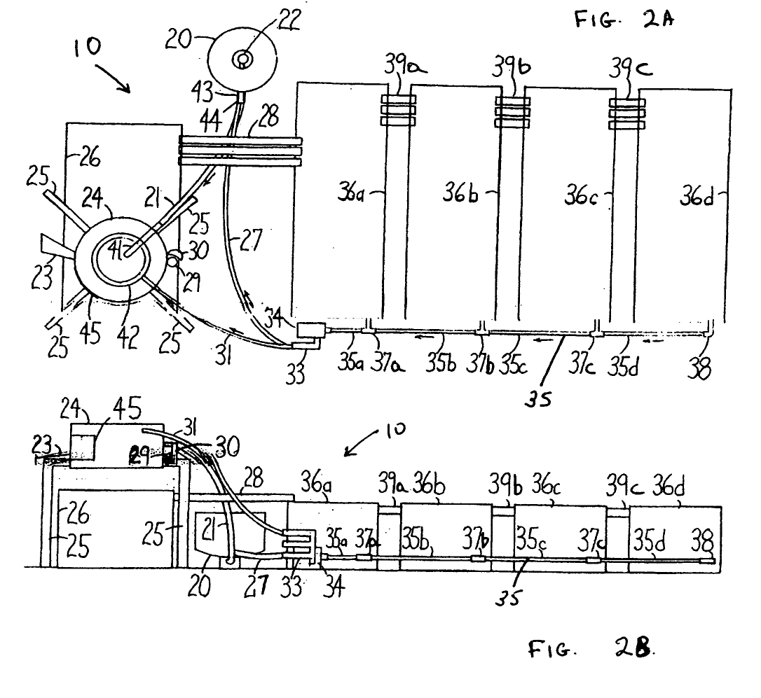

Referring now to FIGS. 2A and 2B, there is shown a concrete reclaimer 10 in accordance with another embodiment of the present invention. Concrete reclaimer 10 includes a hopper 20, a pump 22, a separator 24, a sand tank 26 and water holding tanks 36a, 36b, 36c and 36d, connected in series.

Pump 22 is mounted at the bottom of hopper 20 for pumping material from hopper 20 to separator 24 via a hose 21 which is removably connected to pump 22 by quick connect/disconnect couplings. Pump 22 is attached to discharge pump connection 44. In a typical application, discharge pump 22 is rated at ten horsepower with a four inch discharge port and has the ability to pass three and one half inch solids and pump water at six hundred fifty gallons per minute at fifteen feet of head.

Hopper 20 and separator 24 are connected to a water distribution manifold 33 by a hose 27 and a hose 31, respectively, fitted with quick connect/disconnect couplings for receiving water recirculated from tanks 36a, 36b, 36c and 36d, as hereinafter described. Supply tee 43 connects hose 27 to hopper 20.

Separator 24 has a bottom discharge opening for flowing material from the bottom of separator 24 to tank 26 below. Separator is supported above tank 26 by four adjustable leg assemblies 25. A chute 23 is attached to separator 24 for removing material therefrom. A hatch 45 on separator 24 provides access to the interior of separator 24. A drive mechanism 29 is mounted on the outside wall of separator 24. Drive mechanism 29 is covered by cover 30.

Three pipes 28 connect tank 26 to tank 36a for flowing overflow material from tank 26 to tank 36a. Three pipes 39a connect tank 36a to tank 36b for flowing overflow material from tank 36a to tank 36b; three pipes 39b connect tank 36b to tank 36c for flowing overflow material from tank 36b to tank 36c; and three pipes 39c connect tank 36c to tank 36d for flowing overflow material from tank 36c to tank 36d. The inlets of pipes 39a, 39b and 39c are mounted about one foot bellow the mouths of tanks 36a, 36b and 36c, respectively, to allow for the collection of twelve inches of rain in case of a heavy rainfall.

Discharge assemblies 37a, 37b, 37c and 38 at the bottoms of tanks 36a, 36b, 36c and 36d, respectively, are connected to hose 35 comprised of hose portions 35a, 35b, 35c and 35d for flowing material by gravity from tanks 36a, 36b, 36c and 36d to hose 35. Hose portion 35a is connected to a pump 34 that discharges material to manifold 33 which is connected to hoses 27 and 31 and a utility hose (not shown). Pump 34 is rated at five horsepower with a three inch inlet and a three inch discharge and has the ability to pass ⅜ inch solids and pump water at four hundred gallons per minute at ten feet of head.

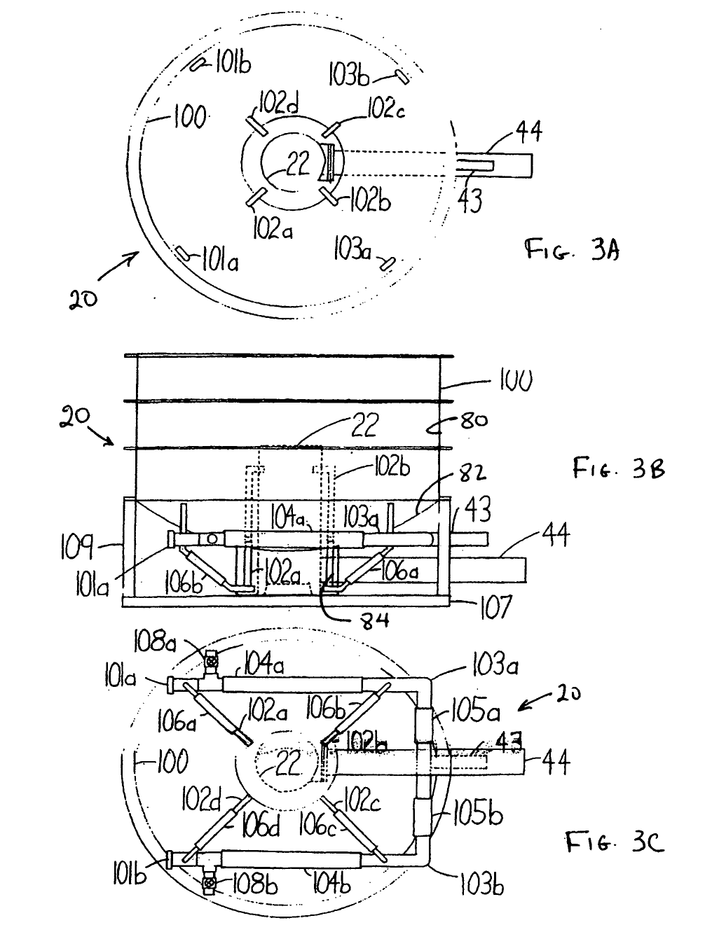

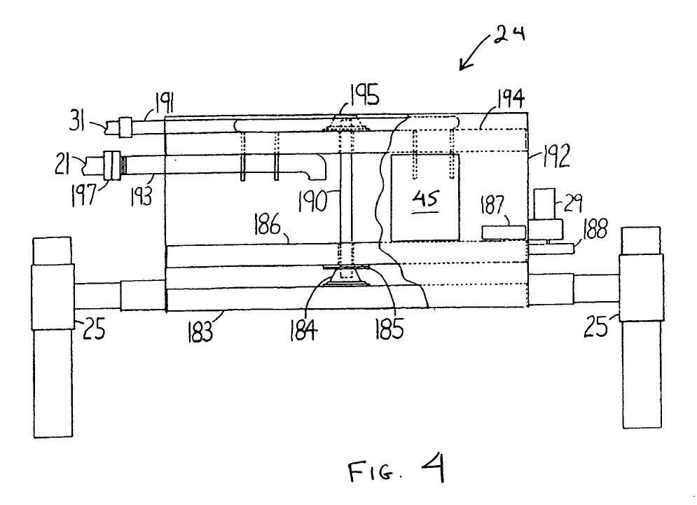

Referring now to FIGS. 3A, 3B and 3C, hopper 20 includes a hopper holding tank 100 having an upper cylindrical portion 80, a bottom dish 82 and a lower reduced diameter cylindrical portion 84, all seam welded together. Upper cylindrical portion 80 is preferably formed by welding in series a rolled channel, a rolled flat bar and another rolled channel. The upper edge of holding tank 100 is at a height which is suitable for receiving discharge of waste, uncured concrete from a concrete mixer truck.

Forward water manifolds 101a and 101b and rear water manifolds 103a and 103b provide water to the interior portion of holding tank 100. They also provide water to the hopper lower water supply and pump cooling nozzles 102a, 102b, 102c and 102d. Forward water manifolds 101a and 101b include ports with valves 108a and 108b, respectively, to supply water to mixer trucks for mixer drum wash out and for filling water tanks. Forward water manifold 101a is connected to rear water manifold 103a via a hose 104a and manifold 101b is connected to rear water manifold 103b by a hose 104b. Rear water supply manifolds 103a and 103b are connected to a supply tee 43 using hoses 105a and 105b, respectively. Hopper lower water supply and pump cooling nozzle 102a is connected to forward water manifold 101a via a hose 106a, nozzle 102b is connected to manifold 103a via a hose 106b, nozzle 102c is connected to manifold 103b via a hose 106c and nozzle 102d is connected to manifold 101b via a hose 106d. Hopper lower water supply and pump cooling nozzles 102a, 102b, 102c and 102d provide water to lower portion of hopper holding tank 100 and cooling water for discharge pump 22. Forward water manifolds 101 a and 101 b, rear water manifolds 103a and 103b, hopper lower water supply and pump cooling nozzles 102a, 102b, 102c and 102d, and water supply tee 43 are all assembled using standard plumbing components. Water supply tee 43 is connected to a pump (not shown) supplying concrete waste water under pressure to hopper 20 at 15 to 20 PSI and at a volume of 250 to 300 gallons per minute.

The threaded end of a discharge pump connection 44 is inserted through a port (not shown) in the lower part of hopper holding tank 100. A flange (not shown) is threaded on to discharge pump connection 44. The flange is bolted to the discharge port of the hopper discharge pump. Discharge pump connection 44 is seam welded into the port in the lower part of hopper holding tank 100.

Hopper holding tank 100 is supported in an upright, stable position through the use of a plurality of hopper support legs 109 welded to the underside flange of the lowest rolled channel comprising the body of hopper holding tank 100 and welded to the inside of a hopper rolled base angle 107

Referring now to FIG. 4 there is shown separator 24. Separator 24 is supported by adjustable separator support legs 25 welded at ninety degree intervals on a separator cylinder 192. Separator cylinder 192 contains a lower bearing support 183 welded inside separator cylinder 192, A lower shaft bearing 184 is attached to bearing support 183. A shaft slinger and screen wheel mounting plate 185 is welded to a screen wheel shaft 190. Screen wheel shaft 190 together with screen wheel mounting plate 185 bolted to a screen wheel 186 rests on lower shaft bearing 184. Above screen wheel 186 is located a gravel discharge port 187 in separator cylinder wall 192. Screen wheel 186 is rotated by a screen wheel drive wheel 188 attached to a screen wheel drive mechanism 29. An upper bearing support 194 bolted inside separator cylinder 192 holds an upper shaft bearing 195 and a rinse water supply pipe and spray manifold 191. Hatch 45 is located on separator cylinder 192 adjacent to gravel discharge port 187. A slurry discharge pipe 193 is inserted through a port (not shown) in the wall of separator cylinder 192. A quick connect/disconnect coupling 197 is attached to the threaded end of slurry discharge pipe 193. Slurry discharge hose 21 is connected to slurry discharge pipe 193 by coupling 197. Water is provided to rinse water supply pipe and spray manifold 191 installed through a port (not shown) in the wall of separator cylinder 192 by hose 31.

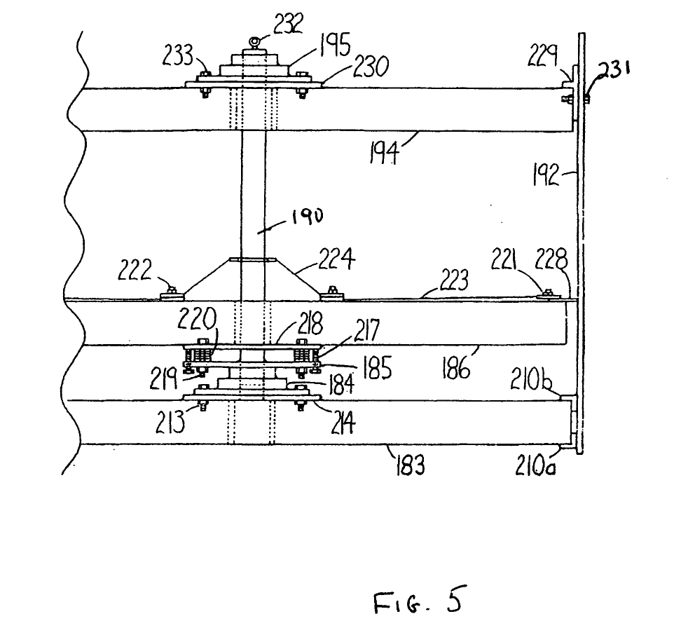

The details of screen wheel 186, mounting system and lower bearing support 183 and upper bearing support 194 are shown in FIG. 5. Lower bearing support 183 is centered and held in place by a lower bearing support rolled angle bottom centering shim 210a and a lower bearing support rolled angle top centering shim 210b which, after placed in position, are both welded to lower bearing support 183 and separator cylinder 192. A bearing mounting plate 214 is centered and welded on a lower bearing support hub (not shown) and welded to the lower bearing support spokes (not shown). Lower shaft bearing 184 is attached to bearing mounting plate 214 using four bolts and nuts 213. A screen wheel shaft 190 with shaft slinger and screen wheel mounting plate 185 welded in place is inserted into lower shaft bearing 184. Screen wheel mounting plate 218 (welded to screen wheel 186) is leveled inside separator cylinder 192 by four adjusting bolts 217 and held in place by four bolts and nuts 219 with shims 220. Screen wheel 186 is surfaced with a circular screen 223 with a rolled flat bar (not shown) welded to the inside and outside perimeter of the round screen. Circular screen 223 is attached to screen wheel 186 by a plurality of nuts and mounting studs 221 welded to the top side of the rolled channel (not shown) comprising the perimeter of screen wheel 186. A flexible gasket 228 is provided to seal between screen wheel 186 and separator cylinder 192. A conical screen 224 is placed at the center of screen wheel 186 also with a rolled flat bar (not shown) welded to the inside and outside perimeter of conical screen. Conical screen 224 is attached to round screen 223 by nuts and mounting studs 222 welded to the top of the inside perimeter rolled flat bar of round screen 223. Upper bearing support 194 is centered and held in place inside separator cylinder 192 by a plurality of shims 229 and bolts and nuts 231. A bearing mounting plate 230 is welded to a upper bearing support hub (not shown) and to the upper bearing support spokes (not shown). Upper shaft bearing 195 is attached to the bearing mounting plate by four bolts and nuts 233. Finally, a lifting eye 232 is welded to the top of screen wheel shaft 190.

FIG. 6 sets forth the details of separator support leg 25. A leg extension mount 258 is welded to the side of separator cylinder 192 opposite to the placement of lower bearing support 183 and lower bearing support rolled angle bottom centering shim 210a and lower bearing support rolled angle top centering shim 210b. A leg extension 253 with a vertical leg square tube 259 welded in place is inserted into leg extension mount 258. A top leg extension stabilizing shim 254 and a side leg extension stabilizing shim 255 are placed between the inside wall of leg extension mount 258 and the outside wall of leg extension 253. Leg extension 253 is held in leg extension mount 258 by a bolt 257 and a nut 256 welded to the top side of leg extension mount 258. A vertical leg 245 is inserted inside vertical leg square tube 259 (welded to the end of leg extension 253). Vertical leg 245 is held in place by an upper side leg stabilizing shim 251, an upper back leg stabilizing shim 252, a lower side leg stabilizing shim 249, and a lower back leg stabilizing shim 250. Hardened bolts 247 hold vertical leg 245, lower side leg stabilizing shim 249, lower back leg stabilizing shim 250 and vertical leg keeper 248 in place. A plurality of leg height adjusting holes 246 are provided to adjust separator 24 to the proper height. The vertical leg height is further adjusted by a lower leg adjustment plate 240 with four welded adjusting studs 241, an upper leg adjustment plate 244 welded to vertical leg 245 and held in place with three adjusting lock nuts 243a, 243b and 243c for each adjusting stud 241.

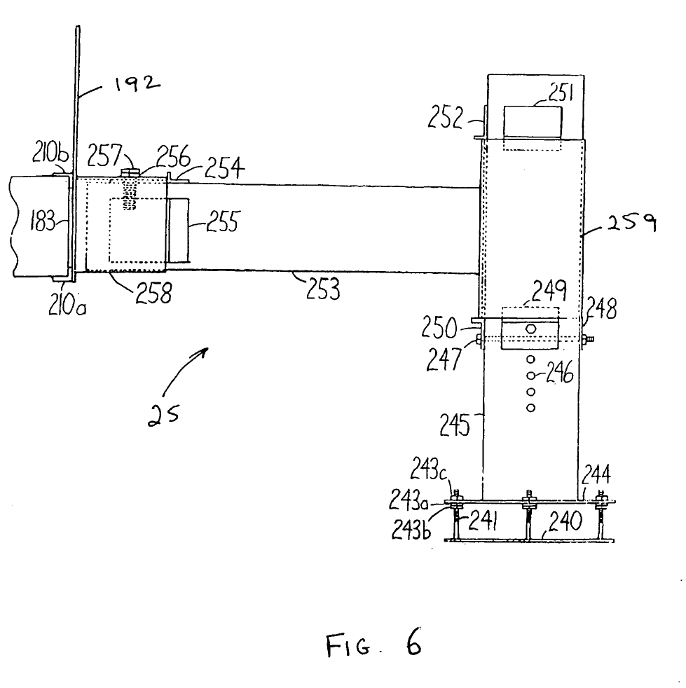

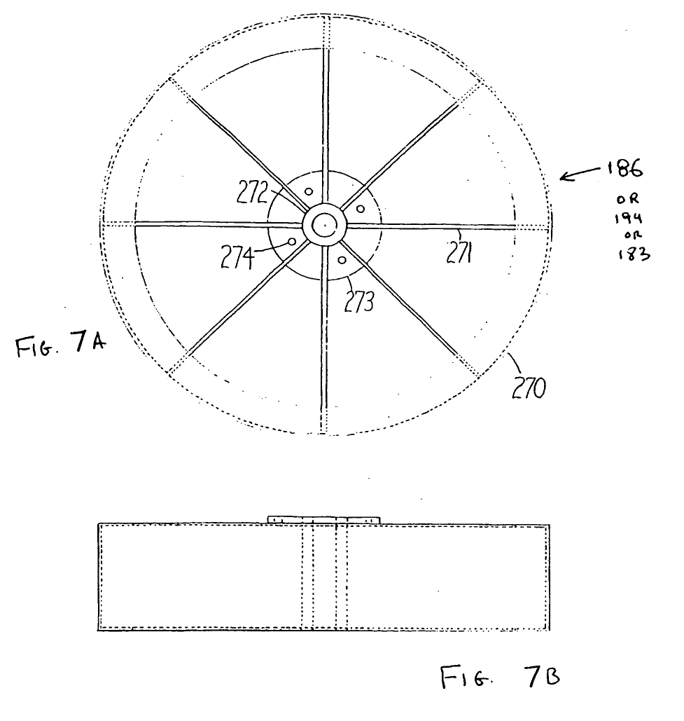

FIGS. 7A and 7B show the details of screen wheel 186, upper bearing support 194 and lower bearing support 183, three pieces that are similarly constructed. The perimeter of screen wheel 186, upper bearing support 194, and lower bearing support 183 is comprised of a rolled channel wheel 270 with flanges inside. A hub 272 is centered inside rolled channel wheel 270 and a plurality of flat bar spokes 271 are welded to rolled channel wheel 270 and hub 272. A mounting plate (plate 214 in the case of lower bearing support 183, plate 218 in the case of screen wheel 186 and plate 230 in the case of upper bearing support 194) is centered over hub 272 and welded to hub 272 and flat bar spokes 271. Four mounting holes 274 drilled in the mounting plates facilitate the attachment of upper shaft bearing 194, lower shaft bearing 184 and screen wheel shaft 190.

Screen wheel drive system 29 is shown in FIGS. 8A and 8B. A gear box 301 and an electric motor 302 are bolted to a screen wheel drive system mounting plate 308. Screen wheel drive wheel 188 is mounted on gear box 301. Screen wheel drive wheel 188 is rotated by gear box 301 and electric motor 302 at a speed to rotate screen wheel 186 at approximately sixty revolutions per minute. Screen wheel drive wheel 188 is positioned in a port on the side of separator cylinder 192 to contact screen wheel 186. Two mounting hinges 312 are welded to screen wheel drive system mounting plate 308 and separator cylinder 192. Screen wheel drive wheel 188 is held against screen wheel 186 by two mounting studs 304a and 304b welded to separator cylinder 192 and inserted through two holes (not shown) in screen wheel drive system mounting plate 308. A tensioning adjustment mechanism 313a around stud 304a consists, in sequence, of a steel washer 305a, a rubber washer 307a, a steel washer 314a, a tensioning spring 303, a steel washer 315a, a rubber washer 316a, a steel washer 317a and a lock nut 306a. A similar tensioning adjustment mechanism 313b is provided around stud 304b. Mechanisms 313a and 313b are used to adjust the engagement between screen wheel drive wheel 188 and screen wheel 186.

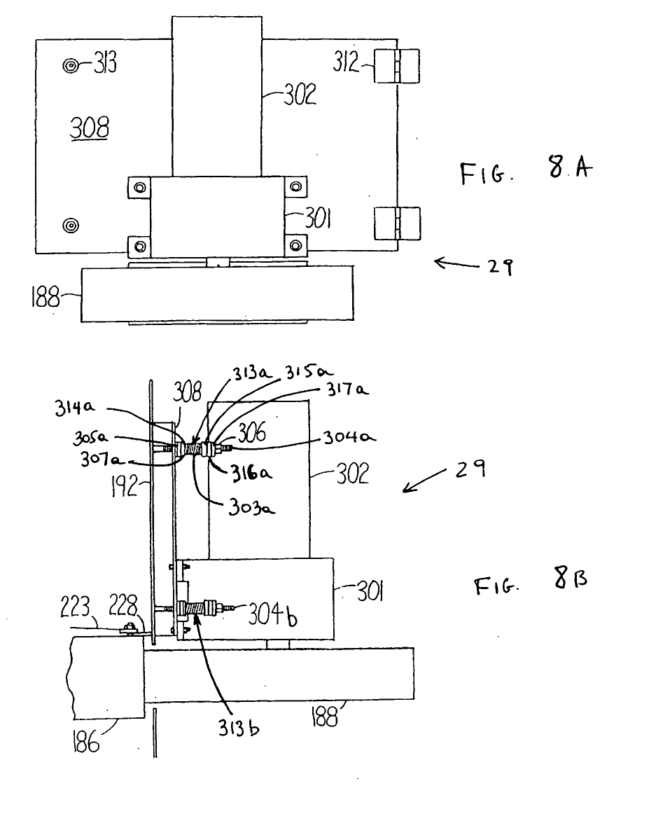

FIGS. 9A and 9B set forth the details of rinse water supply pipe & spray manifold 42. A spray pipe manifold 351 is rolled into a circle with a weld tee 355 welded at each end of spray pipe manifold 351. A weld nipple 356 (threaded on one end) is welded to weld tee 355. Separator water supply hose 31 is connected to weld nipple 356 by a quick connect/disconnect coupling 350. A plurality of holes (not shown) are drilled on the underside of spray pipe manifold 351 and a nipple threaded on one end 352 is inserted and welded in each hole. A threaded coupling 354 is attached to each nipple 352. A fan spray jet 353 is then installed in each threaded coupling 354. Nipple 352, threaded coupling 354, and fan spray jet 353 comprise spray assembly 357.

Referring now back to FIGS. 2A and 2B, sand holding tank 26 and water holding tanks 36a, 36b, 36c and 36d are waste industry standard roll on/roll off containers, each equipped with a water tight door. As stated previously, tank 36a overflows to tank 36b, tank 36b overflows to tank 36c and tank 36a overflows to tank 36b via pipes 39a, 39b and 39c, respectively., Referring now back to FIGS. 2A and 2B and FIGS. 3A, 3B and 3C, in operation, a concrete mixer truck (not shown) carrying unused, uncured concrete positions its discharge chute over hopper 20. Prior to discharging the concrete into hopper 20, the system is turned on to activate the pumps and to begin the rotation of screen wheel 186. Pump 34 is activated to begin pumping water to hopper 20 and separator 24 via hoses 27 and 31, respectively. The water flows into hopper 20 through the nozzles previously described in detail into the upper portion of hopper 20 to create a water swirling action and into the lower portion of hopper 20 to further break up and dilute the uncured concrete and to cool discharge pump 22. The concrete from the truck as well as any washed material from the truck concrete container is then discharged into hopper 20 where is it contacted by the water to create a diluted concrete slurry which is pumped by pump 22 to the upper portion of separator 24 through line 21. Therein, the water is sprayed through sprayers described above with water being provided by hose 31. The slurry flows by gravity inside separator 24. When the slurry reaches rotating screen wheel 186 which has a circular screen 223 and conical screen 224 thereon, rock material larger than 1/4 inches is screened out from the slurry and is centrifugally directed to port 187 for discharge from separator 24 through chute 23. The remaining material comprising cement, sand and water slurry flows by gravity to the bottom of separator 24 and exits therefrom through its open end to fall by gravity to sand tank 26 where most of the sand settles. The effluent from tank 26 flows via pipes 28 to water holding tank 36a. Overflow from tank 36a flows to tank 36b through pipes 39a. Overflow from tank 36b flows to tank 36c through pipes 39b. Overflow from tank 36c flows to tank 36d through pipes 39c. Water is continuously removed from the bottom of tanks 36a, 36b, 36c and 36d via discharge assemblies 37a, 37b, 37c and 38, respectively, to hose 35 which is connected to pump 34. Pump 34 discharges the water to manifold 33 which is connected to hoses 27 and 31 and a utility hose (not shown). The utility hose can be used to provide water for washing the truck concrete container, draining the water tanks and to perform any other utility tasks customary in the industry. In the process described, the rock is separated from the concrete slurry in separator 24, the sand is separated from the water/cement slurry in tank 26 and cement light material is separated from the water in tanks 36a, 36b, 36c and 36d. The separated rock, sand and light cement material are thus recovered for future use.

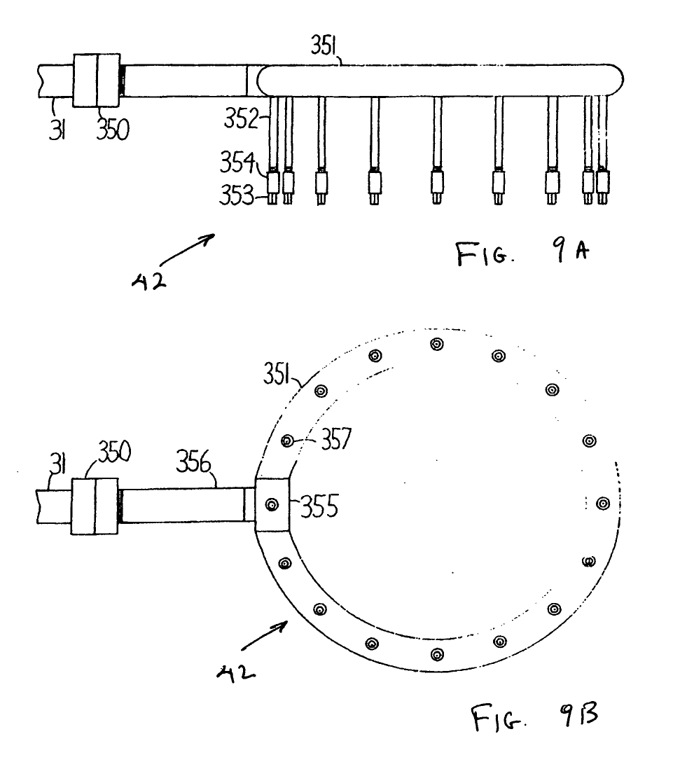

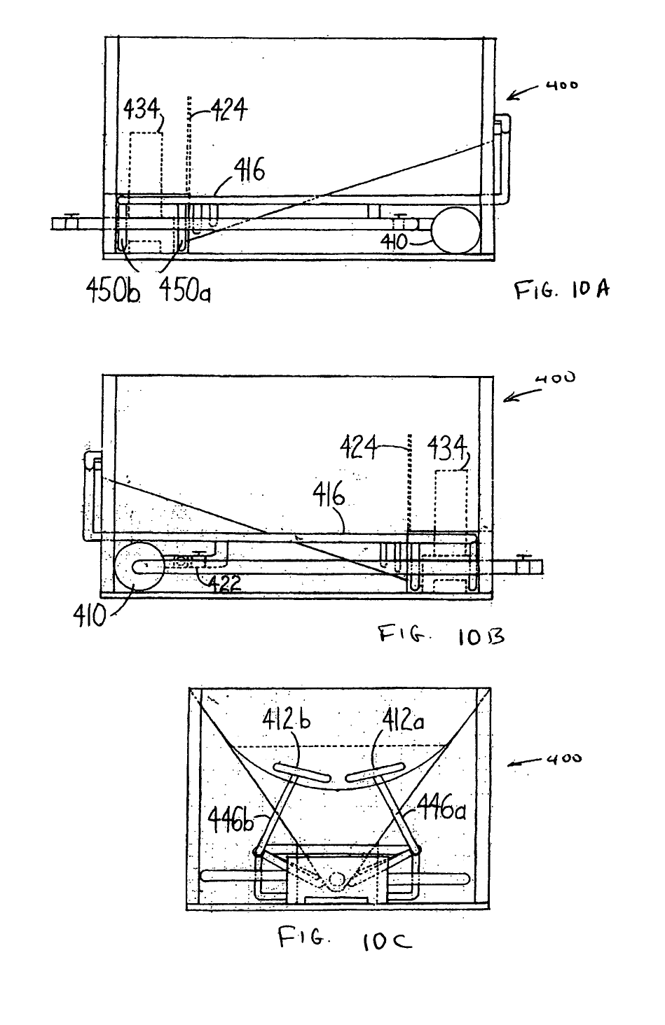

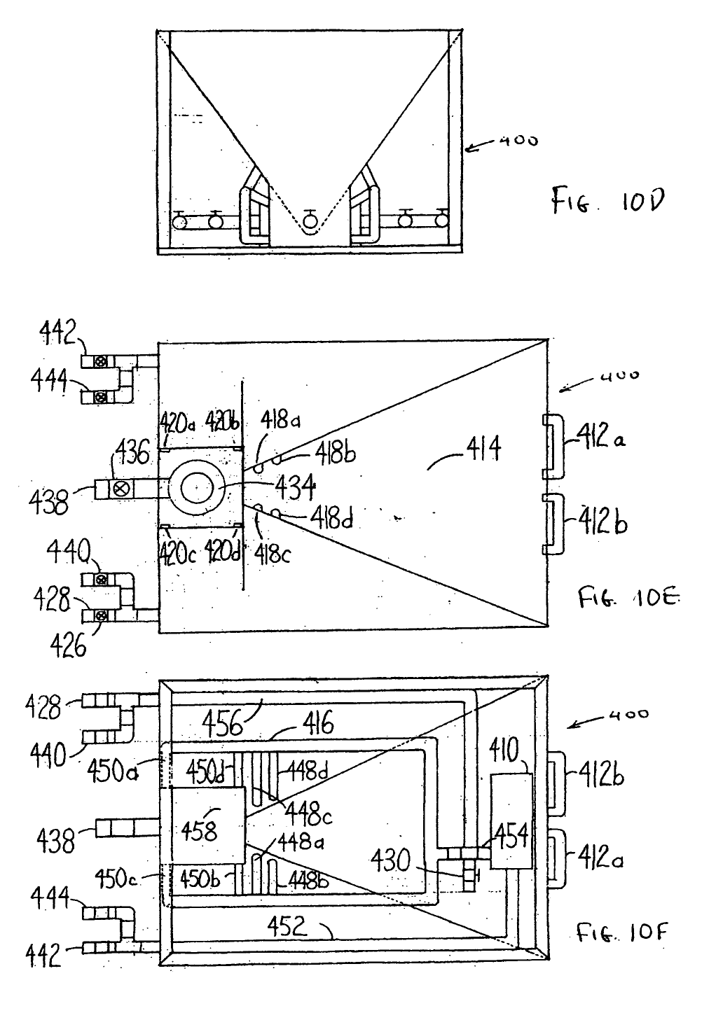

Hopper 20 and pump 34 are preferably used in connection with concrete reclaimer 10 when the material being handled is one inch sieve size or less. In the event the material being handled is larger, it is preferred that hopper 20 and pump 34 of concrete reclaimer 10 be replaced with a hopper 400 suitable for handling large and dense material such as river rock that will pass though a sieve size up to 1.5 inches. Referring now to FIGS. 10A, 10B, 10C, 10D, 10E and 10F, there is sown hopper 400 having a discharge chute 414, shaped as ⅓ of a cone welded in a sloped disposition with the wide end elevated and the narrow end welded into the opening in a sump 458. The upper edge of discharge chute 414 is at a height suitable for receiving discharge of waste, uncured concrete from a concrete mixer truck.

Slurry water flows to water supply pump 410 via a water tank drain hose connection with on/off valve 442 or a sand container drain hose connection with on/off valve 444 and the water supply pump fill pipe 452 Hose 442 is only used to drain excess water from the sand container before removing sand.

The slurry water is discharged from water supply pump 410 via a water supply pump discharge connection 454. The slurry water flows through water supply pump discharge connection 454 into a utility hose connection 432 equipped with a utility hose valve 430, a separator/batch plant water supply pipe 456, and a discharge chute and sump water supply manifold 416.

The slurry water flowing through separator/batch plant water supply pipe 456 is supplied to separator 24 (shown in FIG. 2A) via the separator water supply hose connection. The flow of the slurry water to separator 24 is regulated via a separator water supply metering valve 426. Alternatively, the slurry water flowing through separator/batch plant water supply pipe 456 is supplied for general batch plant use via a batch plant water supply hose connection with on/off valve 440.

The slurry water flowing through the discharge chute and sump water supply manifold is supplied to discharge chute upper water nozzles 412a and 412b, discharge chute lower water nozzles 418a, 418b, 418c and 418d, and sump water nozzles 420a, 420b, 420c and 420d via the water supply line to discharge chute upper water nozzles 446a and 446b, water supply line to discharge chute lower water nozzles 448a, 448b, 448c and 448d, and water supply line to sump water nozzles 450a, 450b, 450c and 450d. The slurry water flowing through the discharge chute and sump water supply manifold is metered using a hoper water supply metering valve 422.

The slurry water and the uncured concrete introduced into the discharge chute 414 flows down the chute to a slurry metering baffle 424. At the bottom of the slurry metering baffle 424 where it is welded to the lower end of the discharge chute 414 is a hole having the same size diameter as the suction end of slurry discharge pump 434. This hole regulates the flow of uncured concrete mixed with slurry water into the sump 458 so as not to overcome the pumping capacity of slurry discharge pump 434. Slurry discharge pump 434 pumps the concrete slurry mixture to separator 24 via slurry discharge line valve 436 and slurry discharge line hose connection 438.

The system described herein is lightweight and portable whereby it can be easily transported in places where its use is the most efficient and economical. All of its components are above ground whereby it does not require digging pits or the like.

While preferred embodiments of the invention have been shown and described, modifications thereof can be made by one skilled in the art without departing from the spirit of the invention.

What is claimed is:

1. A method of treating uncured concrete that contains gravel, sand and cement, comprising the steps of:
removing the gravel from the uncured concrete to form a gravel product and a sand and cement mixture; and
separating the sand from the sand and cement mixture to form a sand product and a cement product.

2. The method according to claim 1 further including the step of contacting the uncured concrete with water.

3. The method according to claim 2 wherein the step of contacting the uncured concrete with water precedes the step of removing the gravel from the uncured concrete.

4. The method according to claim 2 wherein the amount of water in the step of contacting the uncured concrete with water is sufficient to form a slurry.

5. The method according to claim 2 wherein the water in the step of contacting the uncured concrete with water is injected into the uncured concrete.

6. The method according to claim 2 wherein the water in the step of contacting the uncured concrete with water is under pressure.

7. The method according to claim 2 further including the step of washing the cement off the gravel.

8. The method according to claim 1 wherein the step of removing the gravel from the uncured concrete includes the step of screening the gravel out of the uncured concrete.

9. The method according to claim 8 further including the step of vibrating the gravel.

10. The method according to claim 1 wherein the step of separating the sand from the sand and cement mixture includes the step of settling the sand by gravity.

11. The method according to claim 1 wherein the step of separating the sand from the sand and cement mixture includes the step of raising the sand above the cement.

12. A method of reclaiming uncured concrete that contains gravel, sand and cement, comprising the steps of:
contacting the uncured concrete with water to form a slurry;
removing the gravel from the slurry to form a gravel product and a sand, cement and water mixture; and
separating the sand from the sand, cement and water mixture to form a sand product and a cement water effluent.

13. The method according to claim 12 further including the step of extracting the cement from the cement water effluent to form a cement product.

14. The method according to claim 13 wherein the step of extracting the cement from the cement water effluent includes the step of settling the cement by gravity.

15. The method according to claim 12 wherein the amount of water in the step of contacting the uncured concrete with water is sufficient to form a slurry.

16. The method according to claim 12 wherein the water in the step of contacting the uncured concrete with water is injected into the uncured concrete under pressure.

17. The method according to claim 12 further including the step of washing the cement off the gravel.

18. The method according to claim 12 wherein the step of removing the gravel from the uncured concrete includes the step of screening the gravel out of the uncured concrete.

19. The method according to claim 12 wherein the step of separating the sand from the sand and cement mixture includes the step of settling the sand by gravity.

20. The method according to claim 1 further including the steps of recirculating the cement water effluent to provide water that contacts the uncured concrete in the step of contacting the uncured concrete with the water.
